(19) United States
(12) Patent Application Publication
(10) Pub. No.: US 2010/0088175 A1
(43) Pub. Date: Apr. 8, 2010

(54) Secure Inspection and Purchase Method With Surveillance System

(76) Inventor: Steve Lundquist, Stockbridge, GA (US)

Correspondence Address: Hemingway & Hansen, LLP, 1717 Main Street, Comerica Bank Tower- Suite 2500, Dallas, TX, 75201, US

(21) Appl. No.: 11/989,449

(22) PCT Filed: Dec. 15, 2006
(86) PCT No.: PCT/US2006/048080

§ 371 Date: Jan. 25, 2008

(51) Int. Cl. G06Q 30/00; G06Q 20/00

(52) U.S. Cl. 705/14.34; 705/26

(57) ABSTRACT

The invention is a method for using a payment and inspection service to purchase merchandise on an online sale website. A buyer or seller can select using a payment and inspection service. The buyer pays the payment and inspection service, which holds the payment. The seller ships the item to a store where the payment and inspection service is located. The buyer goes to the store and while being monitored, the buyer inspects the merchandise. Preferably, the buyer is monitored by a camera surveillance system with a video record stored on a computer system. If the buyer accepts the item, he leaves the store with the item and the service releases the payment to the seller less any fees owed. If the buyer does not want to accept the item, he rejects the item, which is then repacked and returned to the seller, and the service refunds the payment, less any fees owed back to the seller.

### TECHNICAL FIELD OF THE INVENTION

A secure method for purchasing items over a computer-based sale site.

### BACKGROUND OF THE INVENTION

Internet businesses of all types have continued to evolve and grow despite the failures of a number of endeavors in the 1990s. The popularity of Internet or online auctions and similar sale sites offering items for sale online using the Internet has grown considerably in recent years. These sites include multiple users where independent sellers and traditional retail vendors such as Sears, Wal-Mart, and even high-end businesses such as Neiman Marcus, list items for sale. Users of online auction and various sale sites can post items for sale as either an auction selling to the highest bidder or at a set sale price. Internet auctions offer a “virtual” flea market with an endless variety of merchandise available for sale to anyone accessing the Internet website using a computer. In January 2002, over 32 million Americans visited an online auction site.

This explosion in e-commerce has fueled a concurrent increase in online fraud as unscrupulous individuals exploit the inherent limitations for remote computer-based sales that occur outside of a traditional retail store using a remote computer sale/purchasing system. Internet-based sales enable person-to-person activities between consumers and individual sellers or small businesses offering merchandise to consumer with whom they have no personal contact. Under these circumstances, fraud can be perpetrated by either the individual consumer buying the item or the individual vendor selling the item. Common frauds include late shipments by the seller beyond the agreed shipping date, listing the same item on multiple auction sites with concurrent multiple bids and sales, delayed mailing of payments, payment by check with insufficient funds, no merchandise shipped at all after being sold, shipping inferior merchandise or different merchandise from that stated in the auction listing, and failure to disclose relevant information about a merchandise item. Counterfeit items are frequently encountered on these sites and can be of sufficient quality to fool most consumers even after receipt. Bogus online pay sites used by the buyer to make the payment with the pay site pocketing the payment is another frequent fraud. Bogus escrow services have also been set up by the seller, buyer, or a third party to steal payment for sold items. Fraudulent sellers that do not intend to ship or even possess the merchandise is another problem.

Other frauds frequently encountered on online auctions include bid siphoning. This occurs when a con artist lures bidders off a legitimate auction site by offering to sell the same item for less to the bidder. By going off-site to purchase an item, a buyer loses any protection that might have been gained by purchasing the item on the website. Shill bidding is another fraud that occurs when a seller bids on his own auction item to increase price. This has been an increasing problem on eBay and other similar auction sites. Bid shielding is another fraud where a fraudulent buyer submits a very high bid beyond the item's value. This discourages other bidders from placing bids, but when the bid is nearing its closing, the fraudulent buyer retracts the bid so that a confederate can bid at a much lower price and purchase the item for less than it would have legitimately brought. Second chance offers is another fraud where a con artist seller offers an item to a losing bidder on a closed auction a second chance to purchase the same item, which also results in lost protections by going off-site to complete a purchase.

More recent problems have surfaced with fake check and money order scams. The proliferation of sophisticated computer document generating software and high quality printers permit the creation of legitimate appearing fake checks and money orders. Fraudulent buyers can create very convincing fake cashier checks, personal checks, corporate checks, and even postal money orders to use to pay for items purchased online. The quality of these counterfeit checks have progressed to the point that bank tellers are fooled and it is not till the check is dishonored as counterfeit that the true nature of the check is learned by the seller, after the merchandise has been shipped.

Sale site operators are increasingly concerned with fraud and the potential for fraud, because fraud has an increasing impact on profits of the site providers. For example, eBay has lost significant value because of poor financial performance which is attributable in part to the fraudulent activities surrounding sales on their website. Both buyer and seller frauds occurs, but it is seller fraud that most concerns users, and auction fraud is the most common Internet fraud complaint reported.

One prior art method of addressing this problem is an escrow service. In theory, a buyer uses an escrow service to pay for the goods. The goods are not shipped until the escrow services reports receipt of the funds. The escrow service receives the payment from the buyer and forwards it to the seller only after the buyer confirms satisfactory delivery. However, many escrow services are fraudulent, and the false nature of the service is rarely discovered until the defrauded seller or buyer has already suffered the loss.

Furthermore, even with legitimate escrow services, there are potential problems for the seller. For example, a buyer may return an item after using it with a claim that it has not been used. A wedding or prom dress actually worn can be returned with the claim that it is not used. Books can be read or even photocopied. Rare autographed books by famous authors can have the autographed page slit free with a razor. Other valuable manuscripts, such as a bound print collection, can have pages removed using a similar method. Other products can be opened or tampered with and parts or accessories removed prior to delivery to the purchaser or prior to return to the seller for a refund. Other parts can be swapped with non-original substandard parts. A bogus product, such as an identical TV or computer chassis filled with weight ballast, can be returned as the genuine item for a refund, or an identical used and/or broken product returned for a full refund.

There is a need for a method of ensuring satisfactory delivery of items ordered online and payment for those items with little or no chance of fraud by either the seller or the buyer. A method where the item can be inspected and returned without chances of tampering, alteration, or switching would prevent most if not all of these types of frauds. The method should also include verification of funds transfer before delivering merchandise to a buyer.

### SUMMARY OF THE INVENTION

The invention is a method for securely inspecting merchandise purchased online prior to the transfer of the funds to the seller and completion of the online purchase. The buyer or seller can select use of this service. The service can be paid for by the sale site, a service charge to the buyer or the seller, or a flat rate to the service operator. After the items are purchased online, the items are sent to a storefront payment and inspection site operated by or on behalf of an escrow payment service, or more properly a payment and inspection service. The item purchased is shipped to the inspection storefront or other location by FedEx, UPS, DHL, mail, or other shipper, where it is stored for pickup. The escrow service receives the payment of the purchase price (and shipping costs) for the item. Notification of shipment and arrival at the storefront is provided to the buyer, and then the buyer goes to the storefront and inspects the purchased item within a predetermined period of time. Storage charges can be levied for delays or additional blocks of time can be purchased for storing an item. There may also be a specified standard inspection time within which to accomplish an inspection with additional blocks of time available. There is also a funds verification procedure, so that the service confirms actual availability of the funds before the item is delivered to the buyer.

Once at the storefront, the buyer can examine the item purchased and decide whether to accept it or reject the merchandise during the agreed upon inspection period. The merchandise does not leave the inspection site, and the buyer has a predetermined time frame to accept or reject the item. The buyer can be monitored by an in-person representative or by a surveillance camera system to assure nothing is done to the merchandise. One embodiment of the camera surveillance procedure includes saving digital video of the inspection to a secured storage server so that the video records of the inspection can be provided to the seller to verify that the merchandise was not damaged, tampered with, or replaced by the purchaser. An embodiment using the camera surveillance can also include an inspection alcove or room covered by the surveillance system that can be used as a dressing room also when the system is not actively monitoring the buyer.

If the buyer accepts the merchandise, the funds held by the escrow service are released to the seller. If the buyer rejects the merchandise, the funds held by the escrow service are refunded to the buyer, sometimes with an appropriate deduction for shipping. Actual return shipping charges can be assessed against either the buyer or the seller. Rejected merchandise is returned to the seller without leaving control and custody of the payment and inspection service, so the seller can be assured that the item is being returned unused, unaltered, and not switched with other products.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 shows an embodiment of the customer window at the payment and inspection site.

FIG. 2 is a process flow schematic representation of the prior art method for a seller using an online auction website;

FIG. 3 is a process flow schematic representation of the prior art method for a buyer using an online auction website;

FIG. 4 is a process flow schematic representation of the method for a seller using an online auction website under the invention;

FIG. 5 is a process flow schematic representation of the method for a buyer using an online auction website under the invention;

FIG. 6 is a process flow schematic representation of the prior art method for a seller using an online sale website;

FIG. 7 is a process flow schematic representation of the prior art method for a buyer using an online sale website;

FIG. 8 is a process flow schematic representation of the method for a seller using an online sale website under the invention;

FIG. 9 is a process flow schematic representation of the method for a buyer using an online sale website under the invention;

FIG. 10 offers additional details of for an embodiment of the inspection procedure featuring an enhanced camera surveillance arrangement and privacy alcove.

### DESCRIPTION OF THE PREFERRED EMBODIMENTS

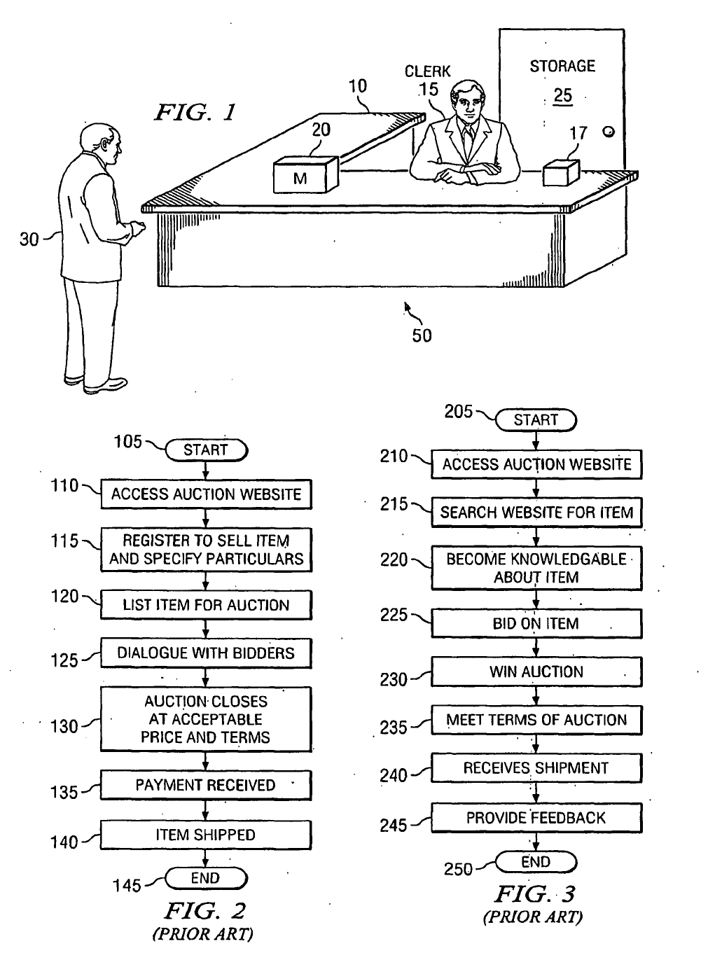

FIG. 1 shows an embodiment for the inspection site in a store setting. The inspection site 5 can be a counter 10 located in space rented, leased or franchised to a store by the payment and inspection service, such as a FedEx Kinko's, Office Depot, Wal-Mart, or other similar retail store operation. Or the inspection site 5 can be owned by the service itself as a stand-alone operation. The inspection site 5 has a counter 10 with a clerk 15. The payment and inspection service receives the shipped merchandise 20, which is made available when the buyer 30 comes to the inspection site 5.

Upon receipt by the service, the merchandise item 20 is placed in a storage location 25. During the purchase process, a specified time to both pickup the item and a time period for inspecting the item are established The storage time can be for a set standard storage period (e.g. one day) with additional storage time blocks available for purchase at the time of the merchandise sale, a graduated charge based on how long the item is stored before inspection assessed before allowing the buyer to inspect the item, or a flat fee assessed for a storage period as part of the price for the escrow service coupled to a rebate and refund if the merchandise is picked up earlier.

Similarly, there should be a standard time limit for performing the inspection after the merchandise is accessed by the buyer at the inspection location. The inspection time can be for a set standard inspection period (e.g. 15 minutes) with additional inspection time blocks available for purchase at the time of the merchandise sale, a graduated charge based on how long the buyer takes to perform the inspection, or a flat fee assessed for an inspection period as part of the price for the escrow service coupled to a rebate and refund if the merchandise is inspected faster.

Typically, the buyer 30 approaches the clerk 5, identifies himself to the clerk 15, and requests the shipped merchandise 20 so he can unpack and inspect the purchased item. The clerk 15 provides access to the shipped merchandise 20 at the counter 10 after receiving any required payments (i.e. storage fee, inspection fee, etc). The clerk 15 will also verify the identity of the buyer or legitimacy of the person asking for the merchandise. The buyer 30 unpacks and inspects the shipped merchandise 20 on the counter 10. While the buyer 30 unpacks and inspects the shipped merchandise 20, the clerk 15 and/or a camera surveillance system 17 monitors the buyer 30. The buyer 30 is not left unmonitored until he accepts the shipped merchandise 20. If the buyer 30 accepts the shipped merchandise 20, then the clerk 15 contacts the service so that the purchase funds are released to the seller, less any fees, such as a fee for the service. If the buyer 30 rejects the shipped merchandise 20, then the clerk 15 repacks the shipped merchandise 20 for return to the seller and contacts the service so that the purchase funds are refunded to the seller, less any amount required for return shipping or other fees, such as a fee for the service.

Either the seller or the buyer can pay for the return shipping. However, the buyer should have an option to purchase for expedited shipment of inspected items to return the item as soon as possible. Similarly, the buyer should be able to pay for expedited shipping of the item to the inspection site.

Although the inspection site is a store location in the preferred embodiment, numerous alternative embodiments are possible. Rather than a store, the inspection site can simply be a delivery truck with or without a built-in inspection compartment. The inspection site can even be at the buyer's home or shipping location under observation of the delivery driver or a delivery clerk, or it can be at a shippers' location, such as a UPS or FedEx shipping facility. It also could be a kiosk in a mall or similar commercial business, or a leased location or franchised location within a larger retail or wholesale store or facility such as a Wal-Mart; Sam's, Home Depot, or Kinkos. The store may also offer coupons or other incentives to attract customers to use that particular inspection location.

FIG. 2 shows an example of a process flow for listing an item on an online auction under the prior art. The process starts at step 105. In step 110, the seller accesses the auction website over the Internet. In step 115, the seller registers to sell the item and specify any particulars. At this point in the process, the seller will select the mode of payment for the item, specify the shipping procedures, describe the item, set a minimum bid, and select the duration time for the auction. In step 120, the seller lists the item for auction. Any fees are paid and the seller uploads any available pictures if desired. In step 125, the seller will engage in dialogue with bidders. Bidders can ask questions about the item or terms for payment or shipment of the item or any other concern by contacting the seller through the auction website, by email, or by phone if the seller has listed a phone number.

In step 130, the auction closes at an acceptable price and terms. The buyer's bid will exceed the minimum amount requested and according to the terms listed on the auction or as agreed to between the buyer and seller. In step 135, the seller receives the payment from the buyer under the payment choice selected, such as cash, money order, credit card, check, use of an online payment service, or use of an escrow service. If using an escrow service, the escrow service accepts and holds the payment until the buyer approves the item. Only after the buyer communicates approval is the payment tendered to the seller. In step 140, the item is shipped to the buyer. Under the prior art, shipping is direct to a buyer's specified address by a shipper, such as FedEx, UPS, DHL, or the U.S. mail. The item is delivered directly to the buyer without any intervention by a third party and only after payment for the item or tendering of the payment to an escrow service. The auction process for the seller then ends at step 145.

FIG. 3 is an example of the process flow of the prior art method for a buyer using an online auction website. The process starts at step 205. At step 210, the buyer accesses the auction website. In step 215, the buyer searches the website for the item. This may involve a focused search using a search function on the website to find specific categories of items based on a keyword or phrase, or the search may be simply browsing the website at random and finding an interesting item that attracts the attention of the buyer. In step 220, the buyer becomes knowledgeable about the item. This may consist of additional research about the item on other Internet websites, consultation with reference books or catalogs, or dialogue with the seller.

At step 225, the buyer places a bid on the item. This process may involve an automated bidding process on the website where a maximum bid amount is specified by the buyer, but the actual amount being bid at any one time depends on the amount of the next lower competing bid. The maximum bid is only reached as the bidding approaches the specified maximum up to the maximum specified. In step 230, the buyer wins the auction by bidding the highest amount that exceeds any specified minimum bid. The buyer must then meet the terms of the bid in step 235. This can include paying by the required mode (e.g. cash, credit card, money order, cashier check, etc) within a required time frame, meeting any agreed shipping options, or resolving any warranty or security issues or concerns (e.g. use of an escrow service). In step 240, the buyer receives the shipment. If an escrow service has been used, the buyer has to contact the escrow service after receiving the item so that the payment is released to the seller. In step 245, the buyer provides feedback on the auction website. Most auction websites promote leaving feedback on users of the site, often both for buyers and sellers, to provide comments on the transaction. The process ends at step 250.

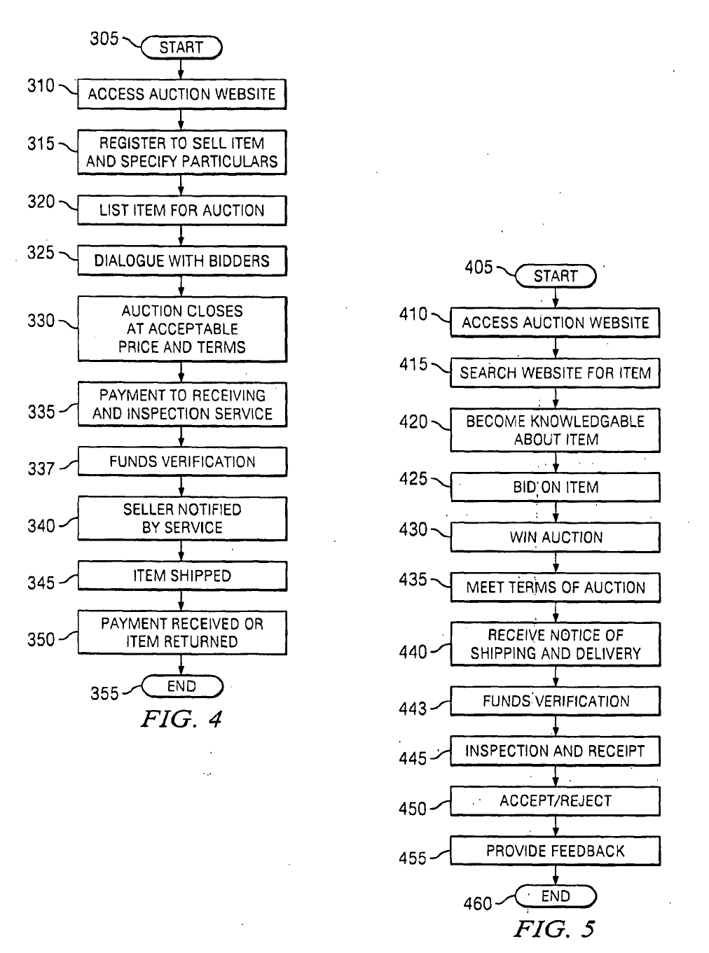

FIG. 4 shows the process flow under the invention for the seller. The process begins at step 305. In step 310, the seller accesses the auction website over the Internet. In step 315, the seller registers to sell the item and specify any particulars. At this point in the process, the seller will select the mode of payment for the item, specify the shipping procedures, describe the item, set a minimum bid, select the duration time for the auction, and select secured payment and inspection option. If the payment and inspection service option is chosen, the buyer will have to comply with the service's terms and select a shipping destination.

At the time the service is chosen, various service options may be specified such as an authentication code to verify legitimacy of the person identity arriving to inspect the item, an authentication code for the product to use to verity the product item and contents of shipped packages, expedited shipping for return if the item is rejected, email notification options for immediately notifying the seller of the status of the purchased item (e.g. shipped, delivered, storage, payment received, payment verified, inspected-accepted, inspected-rejected, payment released, repackaged awaiting pickup, shipped, delivery at return address). Alternatively, at a minimum, similar status information should be able to be tracked for the merchandise after shipping as either standard with the basic service or as a tracking option at additional cost. At this point, the seller may also be able to specify the transportation mode for returning merchandise, such as standard or expedited shipping of returned items. Expedited shipping may be required to return items quickly to put back in inventory or provide tracking for high-value items.

In step 320, the seller lists the item for auction. Any fees are paid and the seller uploads any available pictures if desired. In step 325, the seller will engage in dialogue with bidders. Bidders can ask questions about the item or terms for payment or shipment of the item or any other concern by contacting the seller through the auction website, by email, or by phone if the seller has listed a phone number.

In step 330, the auction closes at an acceptable price and terms. The buyer's bid will exceed the minimum amount requested and according to the terms listed on the auction or as agreed to between the buyer and seller. In step 335, the payment and inspection service receives the payment, and in step 337 the actual availability of payment funds is verified. After verification of the funds in step 337, in step 340 the seller is notified that the payment has been received and is valid with funds available and confirms the shipping address for the location performing the service. However, the buyer is not allowed access to the item without verifying the fund availability. Alternatively, the item can be shipped after receipt of the funds but prior to availability verification. The shipping address is selected by the buyer at the time the payment is made or when making the bid. The seller ships the item to the address for the specified payment and inspection service at step 345. The payment and inspection service may be the shipper (e.g. UPS, FedEx, DHL, etc) or an independent third party. In step 350, the seller either receives the payment from the payment and inspection service or the returned item. If the buyer accepts the item, then the funds are released to the seller. If the buyer rejects the item, then the funds are returned to the buyer, less return shipping fees. The process ends at step 355.

FIG. 5 shows the process flow of the invention for a buyer using an online auction website. The process starts at step 405. At step 410, the buyer accesses the auction website over the Internet. In step 415, the buyer searches the website for the item. This may involve a focused search using a search function on the website to find specific categories of items based on a keyword or phrase, or the search may be simply browsing the website at random and finding an interesting item that attracts the attention of the buyer. In step 420, the buyer becomes knowledgeable about the item. This may consist of additional research about the item on other Internet websites, consultation with reference books or catalogs, or dialogue with the seller.

At step 425, the buyer places a bid on the item. This process may involve an automated bidding process on the website where a maximum amount is specified by the bid, but the actual amount being bid for any amount less than that maximum depends on the amount of the next lower competing bid. The maximum bid is only placed as the bidding approaches the specified maximum. In step 430, the buyer wins the auction by bidding the highest amount that exceeds any specified minimum bid. The buyer must then meet the terms of the bid in step 435. This can include paying by the required mode (e.g. cash, credit card, money order, cashier check, etc) within a required time frame, meeting any agreed shipping options, resolving any warranty or security issues or concerns (e.g. use of an escrow service or the payment and inspection service). During this step, the buyer may have the option of selecting the payment and inspection service or the service may be required by the seller. If used, at this step, the buyer selects a store with a shipping address that is provided to the seller for shipping and pays the service by an acceptable means (e.g. check, credit card, debit card, etc).

During this step in the process, the buyer can select the location from among choices provided by the payment and inspection service. Different pricing may be offered based on location. Options available can include location of the inspection station, type of transport, purchasing additional storage or inspection time, and acceptance or rejection for shipping for delivery or return shipping charges such as expedited shipping, insurance, tracking, or signatures. Different shipping options and modes may also be offered that the buyer selects. Different pricing would be available based on time for delivery offered and selected.

The buyer should also be able to access a linked map showing available inspection stations proximate to the buyer's location. If one or more of the locations offer special incentives, such as coupons or store credits, that information should also be provided to the buyer at this point in the process. Different pricing options may also be charged based on the location selected. The buyer should also be able to choose various service options such as an authentication code to verify legitimacy of the person's identity arriving to inspect the item, an authentication code for the product to use to verity the product item and contents of shipped packages, expedited shipping for shipping the item, email notification options for immediately notifying the buyer of the status of the purchased item (e.g. shipped, delivered, storage, payment received, payment verified, inspected-accepted, inspected-rejected, payment released, repackaged awaiting pickup, shipped, delivery at return address). Alternatively, at a minimum, similar status information should be able to be tracked for the merchandise after shipping as either standard with the basic service or as a tracking option at additional cost.

In step 440, the buyer receives notice of shipping and delivery to the payment and inspection service. The shipping service can provide the payment and inspection service at a company store, such as at a FedEx Kinko's store as one example, but shipping can be by any entity performing that service, such as FedEx, UPS, and DHL, with the inspection service performed in any convenient store location owned, operated and/or licensed by the service. After delivery, the item is maintained in a storage facility at the inspection location. In the preferred embodiment, access to this location will be restricted to authorized employees or agents of the inspection service and/or location. A variable rated based on how long the items is stored may be accessed, which increases revenues for the inspection location and compensates for any storage fees charged to the location. It also provides an incentive to the purchaser for faster pickup of the item. As another option, a flat fee can be assessed for storage in general with a rebate and refund based on when the merchandise is picked. If the buyer does not pick up the item within that time, it is automatically returned to the seller with a full refund to the buyer, less any applicable shipping fees for the return.

In step 443, the service verifies funds validity before the buyer is allowed access to the item. This verification can alternatively occur at several points in the process, but before the item is transferred to the buyer, verification of the payment funds is made. In step 445, after notification, the buyer goes to the store for inspection and receipt of the item. While being monitored, either by an employee or agent of the service or a camera surveillance system, the buyer unpacks the item to inspect while remaining at the inspection location. This inspection can also include examination by an expert to verify authenticity of the purchased item. In step 450, the buyer accepts or rejects the item. If the buyer accepts the item, then the service releases the payment to the seller. If the buyer rejects the item, then the service issues a credit to reimburse the buyer in an amount equal to the purchase price less shipping or other costs. The items is repackaged at the location and promptly returned to the seller. Either the buyer or the seller can pay for shipping the rejected shipment. Should the buyer be solely able and responsible for paying to return the rejected item, usually the lesser expensive option—slower transportation mode—will be selected. Therefore, it is desirable to offer the seller the option to pay for the shipment of rejected items. Thus, the seller can select expedited shipping to get a rejected item returned. In step 455, the buyer provides feedback on the auction website. The process ends at step 460.

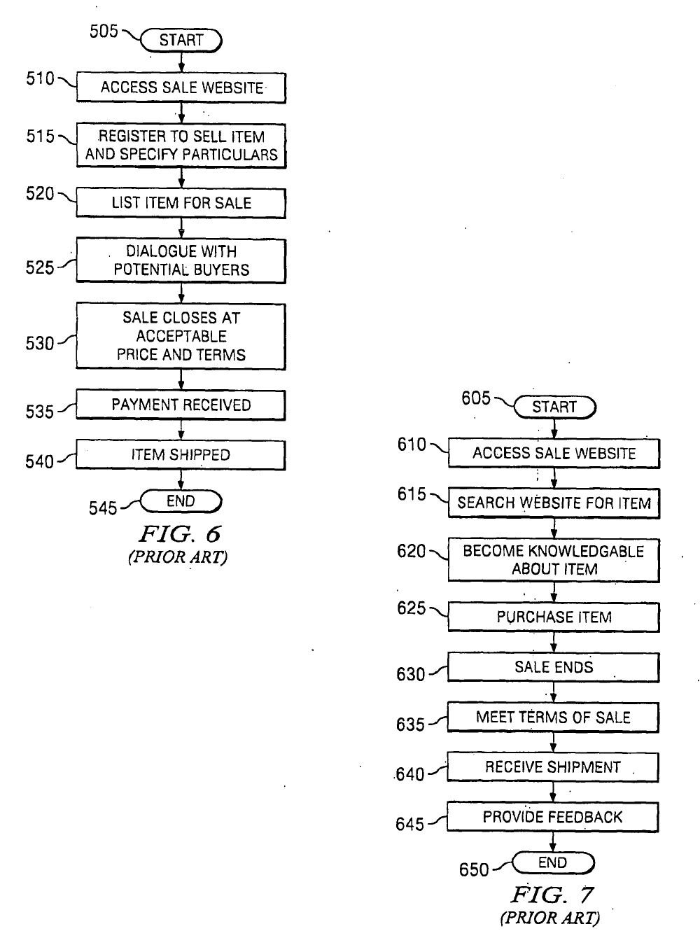

FIG. 6 shows an example of a process flow for listing an item for online sale under the prior art. The process starts at step 505. In step 510, the seller accesses the sale website over the Internet. In step 515, the seller registers to sell the item and specify any particulars. At this point in the process, the seller will select the mode of payment for the item, specify the shipping procedures, describe the item, set a sale price, and select the duration time for the sale listing. In step 520, the seller lists the item for sale. Any fees are paid and the seller uploads any available pictures if desired. In step 525, the seller will engage in dialogue with potential buyers. Buyers can ask questions about the item or terms for payment or shipment of the item or any other concern by contacting the seller through the sale website, by email, or by phone if the seller has listed a phone number.

In step 530, the sale closes at an acceptable price and terms. There may be an option available for an offer below that of the listed sale price that the seller has the option of accepting. In step 535, the seller receives the payment from the buyer under the payment choice selected, such as cash, money order, credit card, check, use of an online payment service, or use of an escrow service. If using an escrow service, the escrow service accepts and holds the payment until the buyer approves the item. Only after the buyer communicates approval is the payment tendered to the seller. In step 540, the item is shipped to the buyer. Under the prior art, shipping is direct to a buyer's specified address by a shipper, such as FedEx, UPS, DHL, or the U.S. mail. The item is delivered directly to the buyer without any intervention by a third party and only after payment for the item or tendering of the payment to an escrow service. The auction process for the seller then ends at step 545.

FIG. 7 is an example of the process flow of the prior art method for a buyer using an online sale website. The process starts at step 605. At step 610, the buyer accesses the sale website. In step 615, the buyer searches the website for the item. This may involve a focused search using a search function on the website to find specific categories of items based on a keyword or phrase, or the search may be simply browsing the website at random and finding an interesting item that attracts the attention of the buyer. In step 620, the buyer becomes knowledgeable about the item. This may consist of additional research about the item on other Internet websites, consultation with reference books or catalogs, or dialogue with the seller.

At step 625, the buyer purchases the item by agreeing to pay the listed price or offering to buy for less than the listed price that the seller accepts. In step 630, the sale ends with the buyer and seller agreeing to any special terms or deviation from the listed price. The buyer must then meet the terms of the sale in step 635. This can include paying by the required mode (e.g. cash, credit card, money order, cashier check, etc) within a required time frame, meeting any agreed shipping options, or resolving any warranty or security issues or concerns (e.g. use of an escrow service). In step 640, the buyer receives the shipment. If an escrow service has been used, the buyer has to contact the escrow service after receiving the item so that the payment is released to the seller. In step 645, the buyer provides feedback on the auction or sale website. Most sale websites promote leaving feedback on users of the site, often both for buyers and sellers, to provide comments on the transaction. The process ends at step 645.

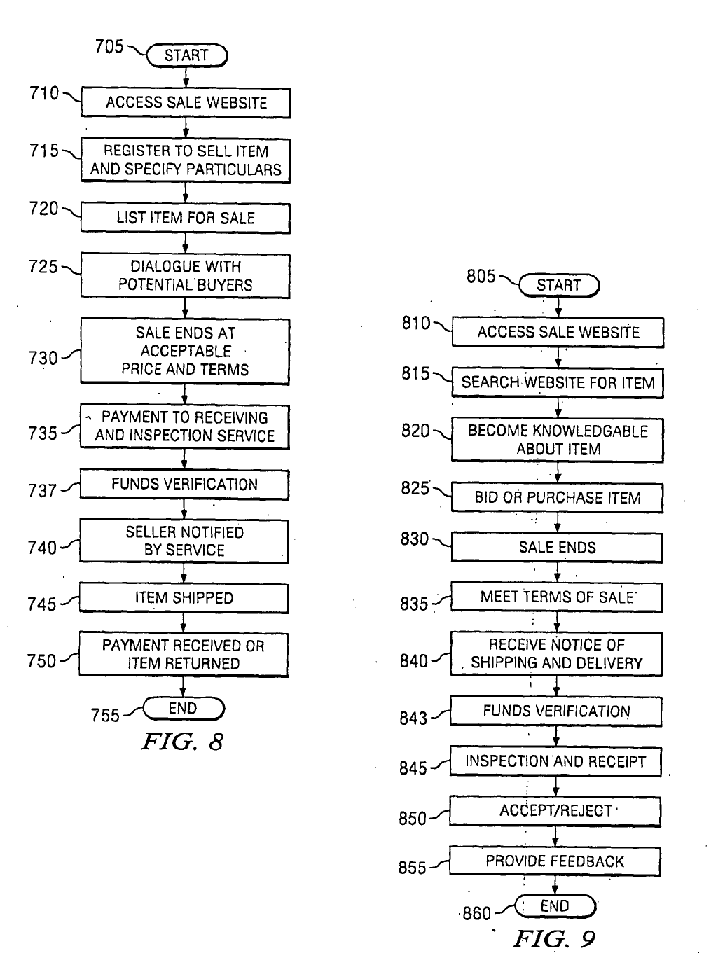

FIG. 8 shows the process flow under the invention for the seller. The process begins at step 705. In step 710, the seller accesses the sale website over the Internet. In step 715, the seller registers to sell the item and specify any particulars. At this point in the process, the seller will select the mode of payment for the item, specify the shipping procedures, describe the item, set a price, select the duration time for the sale, and select secured payment and inspection option. If the payment and inspection service option is chosen, the buyer will have to comply with the service's terms and select a shipping destination.

At the time the service is chosen, various service options may be specified such as an authentication code to verify legitimacy of the person identity arriving to inspect the item, an authentication code for the product to use to verity the product item and contents of shipped packages, expedited shipping for return if the item is rejected, email notification options for immediately notifying the seller of the status of the purchased item (e.g. shipped, delivered, storage, payment received, payment verified, inspected-accepted, inspected-rejected, payment released, repackaged awaiting pickup, shipped, delivery at return address). Alternatively, at a minimum, similar status information should be able to be tracked for the merchandise after shipping as either standard with the basic service or as a tracking option at additional cost. At this point, the seller may also be able to specify the transportation mode for returning merchandise, such as standard or expedited shipping of returned items. Expedited shipping may be required to return items quickly to put back in inventory or provide tracking for high-value items.

In step 720, the seller lists the item for sale. Any fees are paid and the seller uploads any available pictures and if desired. In step 725, the seller will engage in dialogue with potential buyers. Buyers can ask questions about the item or terms for payment or shipment of the item or any other concern by contacting the seller through the sale website, by email, or by phone if the seller has listed a phone number.

In step 730, the sale ends at an acceptable price and terms. In step 735, the payment and inspection service receives the payment. In step 737, the actual availability of the funds is verified. After verification of the funds, in step 740 the seller is notified that the payment has been received and is valid with funds available and confirms the shipping address for the location performing the service. Alternatively, the item can be shipped after receipt of the funds but prior to payment verification. However, the buyer is not allowed access to the item without verifying the fund availability. The shipping address is selected by the buyer at the time the payment is made or when making the bid. The seller ships the item to the address for the specified payment and inspection service at step 745. The payment and inspection service may be the shipper (e.g. UPS, FedEx, DHL, etc) or an independent third party. In step 750, the seller either receives the payment from the payment and inspection service or the returned item. If the buyer accepts the item, then the funds are released to the seller. If the buyer rejects the item, then the funds are returned to the buyer, less return shipping fees. The process ends at step 755.

FIG. 9 shows the process flow of the invention for a buyer using an online sale website. The process starts at step 805. At step 810, the buyer accesses the sale website over the Internet. In step 815, the buyer searches the website for the item. This may involve a focused search using a search function on the website to find specific categories of items based on a keyword or phrase, or the search may be simply browsing the website at random and finding an interesting item that attracts the attention of the buyer. In step 820, the buyer becomes knowledgeable about the item. This may consist of additional research about the item on other Internet websites, consultation with reference books or catalogs, or dialogue with the seller.

At step 825, the buyer purchases the item by agreeing to pay the listed price or offering to buy for less than the listed price that the seller accepts. In step 830, the sale ends with the buyer and seller agreeing to any special terms or deviation from the listed price. The buyer must then meet the terms of the sale in step 835. This can include paying by the required mode (e.g. cash, credit card, money order, cashier check, etc) within a required time frame, meeting any agreed shipping options, resolving any warranty or security issues or concerns (e.g. use the payment and inspection service). During this step, the buyer may have the option of selecting the payment and inspection service or the service may be required by the seller. If the service is used, at this step, the buyer selects a store with a shipping address that is provided to the seller for shipping and pays the service by an acceptable means (e.g. check, credit card, debit card, etc).

During this step in the process, the buyer can select the location from among choices provided by the payment and inspection service. Different pricing may be offered based on location. Options available can include location of the inspection station, type of transport, purchasing additional storage or inspection time, and acceptance or rejection for shipping for delivery or return shipping charges such as expedited shipping, insurance, tracking, or signatures. Different shipping options and modes may also be offered that the buyer selects. Different pricing would be available based on time for delivery offered and selected.

The buyer should also be able to access a linked map showing available inspection stations proximate to the buyer's location. If one or more of the locations offer special incentives, such as coupons or store credits, that information should also be provided to the buyer at this point in the process. Different pricing options may also be charged based on the location selected. The buyer should also be able to choose various service options such as an authentication code to verify legitimacy of the person's identity arriving to inspect the item, an authentication code for the product to use to verity the product item and contents of shipped packages, expedited shipping for shipping the item, email notification options for immediately notifying the buyer of the status of the purchased item (e.g. shipped, delivered, storage, payment received, payment verified, inspected-accepted, inspected-rejected, payment released, repackaged awaiting pickup, shipped, delivery at return address). Alternatively, at a minimum, similar status information should be able to be tracked for the merchandise after shipping as either standard with the basic service or as a tracking option at additional cost.

In step 840, the buyer receives notice of shipping and delivery at the payment and inspection service. The shipping service can provide the payment and inspection service, such as at a FedEx Kinko's store, but shipping can be by any entity in that business, such as FedEx, UPS, and DHL, with the inspection service performed in any convenient store location with an inspection location or even at the home or other location. After delivery, the item is maintained in a storage facility at the inspection location. In the preferred embodiment, access to this location will be restricted to authorized employees or agents of the inspection service and/or location. A variable rated based on how long the items is stored may be accessed, which increases revenues for the inspection location and compensates for any storage fees charged to the location. It also provides an incentive to the purchaser for faster pickup of the item. As another option, a flat fee can be assessed for storage in general with a rebate and refund based on when the merchandise is picked. If the buyer does not pick up the item within that time, it is automatically returned to the seller with a full refund to the buyer, less any applicable shipping fees for the return.

In step 843, the service verifies fund validity before the buyer is allowed access to the item. The verification can alternatively occur at several points in the process, but before the item is transferred to the buyer, actual verification of the funds is made. In step 845, after notification, the buyer goes to the store for inspection and receipt of the item. While being monitored, either by an employee or agent of the service or a camera surveillance system, the buyer unpacks the item to inspect while remaining at the inspection location. This inspection can include examination by an expert to verify the authenticity of the purchased item. In step 850, the buyer accepts or rejects the item. If the buyer accepts the item, then the service releases the payment to the seller. If the buyer rejects the item, then the service issues a credit to reimburse the buyer in an amount equal to the purchase price less shipping costs. The item is repackaged at the store and promptly returned to the seller. In step 855, the buyer provides feedback on the auction website. The process ends at step 860.

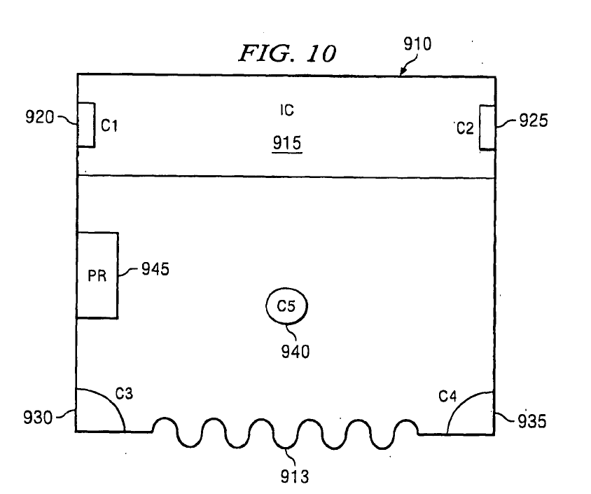

FIG. 10 shows additional details for an embodiment of an inspection system using camera surveillance. In this embodiment, the buyer enters a private alcove 910, which can vary considerably in size but should be of sufficient size to permit two people to enter and accommodate purchased items of at least 72″ (1.83 meters) in length. The private alcove includes a privacy curtain or other barrier 913 that can be closed, so that the buyer can have privacy from other patrons of the location during the inspection. An inspection counter (IC) 915 allows the buyer to unpack the item for inspection on the counter. A packaging rack (PR) 945 is also present, so that the buyer can store the packing material (e.g. box, bubble wrap, packing peanuts, etc) and avoid unnecessary clutter on the inspection counter 915.

Surrounding the inspection counter 915 is an array of multiple video cameras, either small cam cameras similar to ones used in conjunction with computers or high-resolution cameras used in consumer video cameras. The most critical feature of the camera selected provide adequate resolution to clearly record the inspection. Camera 1 (C1) 920 and Camera 2 (C2) 925 provide a left and right view of the inspection counter 915 and are preferably elevated and have slightly different focal locations so that the entire counter 915 can be monitored. Camera 3 (C3) 930 and Camera 4 (C4) 935 are mounted in the rear corners of the alcove 910, preferably in an elevated position, to also aid in providing complete coverage of the counter 915 and surrounding area. Finally, Camera 5 (C5) 940 is positioned in the ceiling of the alcove 910 to provide an overview monitoring perspective looking down into the alcove area. Additionally, the ability for service location employees to turn off the surveillance system so that clothing articles can be tried on as a final check for sizing may be included. In this manner, the privacy alcoves can also serve as changing location for trying on clothing, or separate changing rooms might be provided for this purpose.

In operation, these multiple camera views are uploaded on a computer accessible server, which provides a readily viewable record of the buyer's activities during the inspection. The buyer would be allowed a reasonable period for inspecting the item, which the buyer may be able to specify and which may be linked to variable rates of charge for the inspection service. For example, if the item involved was a baseball supposedly signed by Mickey Mantle, which would require some period of study by an expert to authenticate, the buyer might choose to purchase an inspection period of fifteen minutes. On the other hand, if the item was a clothing article only requiring verification that it is the item shipped and the right size, then the inspection could be a standard time limit, such as five minutes, that does not require any extra payment by the buyer or charge by the service. The standard inspection time limit is variable and user defined, but it is believed that most inspections can be completed within ten minutes. It is further contemplated that additional time will be purchased in standard blocks of a user defined period of time, such as one minute, five minute, or some other block of time.

If the buyer chooses to accept the item, a service employee can make a computer entry to delete the camera recording. However, if the buyer rejects the item for return to the seller, the employee can briefly review the surveillance to ensure that the item was not tampered with or switched before the buyer leaves the location. Only after verifying no tampering or switching of the item would the employee perform the steps necessary to refund the buyer's money. To ensure compliance by the buyer with the desired level of security and rules for the inspection, the employee may obtain the buyer's driver's license and/or credit card before allowing the buyer to inspect the item, and the return those items only after the buyer complies and completes his inspection and accepts or rejects the item. Additionally, the surveillance recording may be retained on a computer system server, either remote to the facility or on the premises, so that the seller can review the surveillance recording for personal assurance that the buyer did not tamper or damage the item before it was repacked for return to the seller. This review may be done using an Internet connection the server, a CD generated and sent to the seller, or a video clip automatically emailed to the seller. A camera surveillance system is preferred for the payment verification and inspection, because it provides a complete record of the inspection that can be accessed by the service, the seller, and even law enforcement should some type of fraud or tampering occur during the transaction that indicates criminal activity.

While the invention has been particularly shown and described with respect to preferred embodiments, it will be readily understood that minor changes in the details of the invention may be made without departing from the spirit of the invention.

Having described the invention, I claim:

1. A method for securely purchasing merchandise on a remote computer purchasing system, comprising the steps of:
routing a payment for an item purchased on a website to a payment and inspection service;
receiving the purchased item at an inspection location after an item has been purchased using the remote computer purchasing system;
verifying funds availability then providing the purchased item to the buyer for inspection at the payment and inspection service inspection location for a specified inspection time period;
monitoring the buyer during inspection of the item using a camera surveillance system mounted in an alcove consisting of multiple cameras providing for overlapping view coverage of an inspection counter used for the inspection;
storing the video from the multiple cameras in a memory storage on a computer system accessible by the service and the seller; and
allowing the buyer to accept the purchased item wherein the payment funds are transferred to the seller, or allowing the buyer to reject the purchased time wherein the payment funds are transferred back to the buyer.

2. The method for securely purchasing merchandise on a remote computer purchasing system of claim 1, further comprising the step of:
providing a privacy door or curtain at the entrance of the alcove and monitoring the buyer with a surveillance camera installed having an overhead monitoring perspective; and
providing at least one other surveillance camera monitoring the designated inspection counter within the privacy alcove.

3. The method for securely purchasing merchandise on a remote computer purchasing system of claim 2, further comprising the step of:
providing a surveillance camera disabling option so that the privacy alcove can be used as a changing room to try on clothing articles.

4. The method for securely purchasing merchandise on a remote computer purchasing system of claim 1 wherein the seller pays for the use of the payment and inspection service through a deduction from the payment funds.

5. The method for securely purchasing merchandise on a remote computer purchasing system of claim 1 wherein the buyer pays for the use of the payment and inspection service.

6. The method for securely purchasing merchandise purchased on a remote computer purchasing system claim 1 wherein a standard predetermined time period is set for storing an item before a buyer arrives to inspect the purchased item.

7. The method for securely purchasing merchandise purchased on a remote computer purchasing system claim 6, further comprising the step of
purchasing additional time for inspection of the purchased item.

8. The method for securely purchasing merchandise purchased on a remote computer purchasing system claim 6, further comprising the step of:
rebating a portion of the fee charged by the service to the buyer if the buyer arrives and completes inspection earlier than the predetermined time period for storing the item.

9. The method for securely purchasing merchandise purchased on a remote computer purchasing system of claim 1 wherein if the buyer rejects the item it is repacked and returned to the seller.

10. The method for securely purchasing merchandise purchased on a remote computer purchasing system of claim 1 wherein if the buyer rejects the purchased item, the payment funds, less any fees, are refunded to the buyer.

11. The method for securely purchasing merchandise purchased on a remote computer purchasing system of claim 10 wherein if the buyer accepts the purchased item, the payment funds, less any fees, are released to the seller.

12. The method for securely purchasing merchandise purchased on a remote computer purchasing system of claim 1, further comprising the step of:
choosing transportation mode and any special expedited handling for shipping purchased items by the buyer.

13. The method for securely purchasing merchandise purchased on a remote computer purchasing system of claim 1, further comprising the steps of:
choosing transportation mode and any special expedited handling for retuning rejected items by the seller.

14. The method for securely purchasing merchandise purchased on a remote computer purchasing system of claim 1 wherein the purchaser can select from multiple shipping options, each with different pricing based on time of delivery and handling options.

15. The method for securely purchasing merchandise purchased on a remote computer purchasing system of claim 1 wherein the buyer can select from multiple shipping options, each with different pricing based on time of delivery and handling options.

16. The method for securely purchasing merchandise purchased on a remote computer purchasing system of claim 1 wherein the purchaser selects the shipping location from multiple choices presented by the payment and inspection service.

17. The method for securely purchasing merchandise purchased on a remote computer purchasing system of claim 16 wherein the payment and inspection service accesses variable rate of fees charged based on the selected location.

18. The method for securely purchasing merchandise purchased on a remote computer purchasing system of claim 1, further comprising the step of:
providing an authentication code to verify person arriving at inspection site has authority to receive and inspect item.

19. The method for securely purchasing merchandise purchased on a remote computer purchasing system of claim 1, further comprising the step of:
providing an authentication code to authenticate the packaging contents as the purchased item.

20. A method for securely delivering merchandise purchased online, comprising the steps of:
receiving payment funds from the buyer of the item at a payment and inspection service;
providing an inspection location having a storage area and at least one area for conducting an inspection of merchandise;
receiving the item at an inspection location operated on behalf of a payment and inspection service from the seller and placing into storage;
allowing the buyer to inspect the purchased item at the inspection location after verifying payment funds availability;
monitoring the buyer during inspection of the purchased item in an inspection area, said inspection occurring inside an alcove having a camera surveillance system installed; and
directing the release of payment funds by the payment and inspection service to the seller if item accepted by buyer, or refunding the payment funds to the buyer upon rejection of the purchased item by the buyer.

21. The method for securely delivering merchandise purchased online of claim 20, further comprising the step of:
providing for deduction of any fees due before releasing or refunding funds by the payment and inspection service.

22. The method for securely delivering merchandise purchased online of claim 20, further comprising the step of:
providing for credit of any fees for rebate or incentive payment before releasing or refunding funds by the payment and inspection service.

23. The method for securely delivering merchandise purchased online of claim 20, further comprising the steps of:
monitoring the inspection using a multiple camera surveillance system mounted in the alcove, including one or more to provide an elevated monitoring perspective; and
storing accessible video images of the inspection on a computer server operated by the service.

24. The method for securely delivering merchandise purchased online of claim 20, further comprising the steps of:
providing the alcove with a privacy screen to block view of the inspection by other patrons.

25. The method for securely delivering merchandise purchased online of claim 24, further comprising the steps of:
providing an accessible switch to turn-off the surveillance system so the buyer can have privacy to try on articles of clothing.

26. The method for securely delivering merchandise purchased online of claim 20, further comprising the steps of:
providing an alcove for inspection of sufficient size for at least two people to be present during the inspection.

27. The method for securely delivering merchandise purchased online of claim 20, further comprising the steps of:
providing a surveillance camera having an overhead view of the inspection area;
providing a surveillance camera having side view.

28. A system for delivering an item bought using an online website, comprising:
a payment and inspection service that receives payment from a buyer for a purchased item listed on a website, said payment verified before delivery of the item to the buyer;
an inspection location where the item purchased is shipped to by the seller, said buyer inspects the item and the payment funds are authorized to be transferred to the seller if the buyer accepts the item, or the payment funds are authorized to be refunded to the buyer if the buyer rejects the item; and
a camera surveillance system mounted inside a privacy alcove having a closeable entrance and used to monitor inspection of the purchased item by the buyer for later access from a computer-accessed memory.

29. The system for delivering an item bought using an online website of claim 28, further comprising:
an employee or agent of the service accessing the camera surveillance record before refunding funds to the buyer.

30. The system for delivering an item bought using an online website of claim 28, wherein the privacy alcove includes at least one camera mounted to provide an overhead monitoring view, an inspection counter, and at least one camera mounted to provide an side monitoring view of the inspection counter.

31. The system for delivering an item bought using an online website of claim 28, wherein the buyer pays a fee for the service.

32. The system for delivering an item bought using an online website of claim 28, wherein the seller pays a fee for the service.

33. The system for delivering an item bought using an online website of claim 28 further comprising:
an option selectable on the sale website to contact and use the service selected by the seller.

34. The system for delivering an item bought using an online website of claim 28 further comprising:
an option selectable on the website to contact and use the service selected by the buyer.

35. The system for delivering an item bought using an online website of claim 28 further comprising:
an option selectable on the website to contact and use the service selected by the seller.

36. The system for delivering an item bought using an online website of claim 28, further comprising:
an option to turn-off the camera surveillance system in the privacy alcove so it can be used as a changing room for trying on clothing items.

37. The system for delivering an item bought using an online website of claim 28, further comprising:
a verification of payment funds availability before allowing the buyer to inspect the item.

38. The system for delivering an item bought using an online website of claim 28, further comprising:
a surveillance camera installed in the alcove having an overhead monitoring perspective; and
providing at least one other surveillance camera monitoring a designated inspection area in the privacy alcove.

39. The system for delivering an item bought using an online website of claim 28, further comprising:
a surveillance camera disabling option so that the privacy alcove can be used as a changing room to try on clothing articles.

40. The system for delivering an item bought using an online website of claim 28, further comprising:
the seller paying for the use of the payment and inspection service through a deduction from the payment funds.

41. The system for delivering an item bought using an online website of claim 28, further comprising:
the buyer paying for the use of the payment and inspection service.

42. The system for delivering an item bought using an online website of claim 28, further comprising:
a standard predetermined time period set for storing an item before a buyer arrives to inspect the purchased item.

43. The system for delivering an item bought using an online website of claim 42, further comprising:
the purchase of additional time for inspection of the purchased item.

44. The system for delivering an item bought using an online website of claim 42, further comprising:
a rebate of a portion of the fee charged by the service to the buyer if the buyer arrives and completes inspection earlier than the predetermined time period for storing the item.

45. The system for delivering an item bought using an online website of claim 28, further comprising:
a repacked item for returning to the seller if buyer rejects the item.

46. The system for delivering an item bought using an online website of claim 28, further comprising:
the transfer of payment funds, less any fees, to the buyer if the buyer rejects the purchased item.

47. The system for delivering an item bought using an online website of claim 46, further comprising:
the transfer of payment funds, less any fees, to the seller if the buyer accepts the purchased item.

48. The system for delivering an item bought using an online website of claim 28, further comprising:
the buyer chooses transportation mode and any special expedited handling for shipping purchased items.

49. The system for delivering an item bought using an online website of claim 28, further comprising:
the seller chooses transportation mode and any special expedited handling for retuning rejected items.

50. The system for delivering an item bought using an online website of claim 28, further comprising:
the purchaser selects from multiple shipping options, each with different pricing based on time of delivery and handling options.

51. The system for delivering an item bought using an online website of claim 28, further comprising:
the buyer selects from multiple shipping options, each with different pricing based on time of delivery and handling options.

52. The system for delivering an item bought using an online website of claim 28, further comprising:
the payment and inspection service presents multiple choices for shipping location for selection to the buyer.

53. The system for delivering an item bought using an online website of claim 28, further comprising:
a variable rate charged by the payment and inspection service based on the selected location.

54. The system for delivering an item bought using an online website of claim 28, further comprising:
an authentication code provided by the payment and inspection service to verify a person arriving at an inspection site has authority to receive and inspect item.

55. The system for delivering an item bought using an online website of claim 28, further comprising:
an authentication code provided by the payment and inspection service to authenticate the packaging contents as the purchased item.
